(19) United States
(12) Patent Application Publication
(10) Pub. No.: US 2016/0033076 A1
(43) Pub. Date: Feb. 4, 2016

(54) Wall Mounting Bracket

(71) Applicant: Karl Hoeltge, O'fallon, MO (US)

(72) Inventor: Karl Hoeltge, O'fallon, MO (US)

(21) Appl. No.: 14/813,613

(22) Filed: Jul. 30, 2015

Related U.S. Application Data
(60) Provisional application No. 62/030,813, filed on Jul. 30, 2014.

(51) Int. Cl. F16M 13/02; F16B 2/22; F16B 11/00

(52) U.S. Cl. CPC F16M 13/022; F16B 11/006; F16B 2/22

(57) ABSTRACT

A wall mounting bracket is provided. The wall mounting bracket is configured to allow a user to suspend an item thereon to be displayed from a wall surface. The wall mounting bracket includes a base portion configured to be placed flush against a wall surface and removably adhered thereto via any suitable fastening method. The base portion includes an adjustable shaft that is configured to be bent to a user's desire and maintain a bent shape. The adjustable shaft includes a fastener configured to removably fasten to the desired display item. Preferably, the fastener is a C-shaped clamp that allows for the item to be displayed from the wall surface.

### CROSS REFERENCE TO RELATED APPLICATION

This application claims the benefit of U.S. Provisional Application No. 62/030,813 filed on Jul. 30, 2014. The above identified patent application is herein incorporated by reference in its entirety to provide continuity of disclosure.

### FIELD OF THE INVENTION

The present invention relates to wall mounting devices. More particularly, the present invention provides a wall mounting bracket that allows items to be displayed from a wall surface. The wall mounting bracket includes a base portion removably securable to the wall surface and an adjustable shaft having a fastener configured to removably fasten to the desired display item.

### BACKGROUND OF THE INVENTION

Many people collect many different types of toys. Some people collect action figures, and others collect figurines. Generally, figurines are figures that have been created to represent a certain character. They typically are molded and have no movable body parts. Furthermore, these figurines are molded with a base to make it easier to stand them up for display. On the other hand, action figures are also toys that are created to represent particular characters, however, they are designed to have at least one movable body part. Action figures can be moved and posed in a variety of positions, but they are harder to display because they lack a base portion.

Generally, collectors can either keep their action figures or figurines within their original packaging. Either way, many collectors have a desire to display these action figures or figurines instead of storing them in a closet. One typical method of hanging these action figures or figurines is to hang them from a wall. Collectors push thumbtacks into the wall and use string to hang the action figures or figures from each thumbtack. Needless to say, sometimes these thumbtacks are not configured to support the weight of heavier items. Therefore, there exists a need for a new and improved wall mounting bracket that allows a user to suspend heavier items thereon.

Devices have been disclosed in the prior art that relate to stands for action figures and dolls. These include devices that have been patented and published in patent application publications. Some devices provide toy supports comprising a base and one or more flexible vertical supports extending upward therefrom, where each of the vertical supports comprises gripping members attached thereto. Other devices provide display stands comprising a base and a vertical post extending upward therefrom, wherein the vertical support comprises a strap system and a bracket for supporting a doll or a figure thereon. These devices, however, fail to provide a base portion having an adhesive or other attach means for securing the wall mounting bracket onto a wall surface.

The present invention provides a wall mounting bracket configured to allow a user to removably fasten heavier items thereto to be displayed on a wall surface. The wall mounting bracket includes a base portion having an interior face and an exterior face, wherein the interior face is removably adhered to a wall surface via an adhesive. The exterior face includes an adjustable shaft that is centrally disposed thereon. The adjustable shaft is configured to be bent and manipulated to a user's desire, and configured to maintain the bent shape. The adjustable shaft includes a fastener thereon configured to removably fasten an item thereto. Preferably, the fastener is a C-shape clamp configured to removably clamp to the desired item to be displayed.

It is therefore submitted that the present invention is substantially divergent in design elements from the prior art, and consequently it is clear that there is a need in the art for an improvement to wall mounting brackets. In this regard, the instant invention substantially fulfills these needs.

### SUMMARY OF THE INVENTION

In view of the foregoing disadvantages inherent in the known types of wall mounting brackets now present in the prior art, the present invention provides a wall mounting bracket wherein the same can be utilized for providing a user with an adjustable wall mounting bracket that allows the user to removably fasten an item thereto to display the item on a wall surface.

It is therefore an object of the invention to provide a new and improved wall mounting bracket that has all of the advantages of the prior art and none of the disadvantages.

Another object of the present invention is to provide a new and improved wall mounting bracket comprising a base portion having an interior face removably adhered to a wall surface via an adhesive.

A further object of the present invention is to provide a new and improved wall mounting bracket, wherein an exterior face of the base portion includes an adjustable shaft affixed thereto.

Yet another object of the present invention is to provide a new and improved wall mounting bracket, wherein the adjustable shaft is configured to be bent and manipulated by a user and maintain the bent configuration.

Still yet another object of the present invention is to provide a new and improved wall mounting bracket, wherein the adjustable shaft includes a fastener configured to removably fasten an item thereto to allow a user to suspend the item from the wall surface.

A further object of the present invention is to provide a new and improved wall mounting bracket, wherein the fastener includes a C-shaped clamp.

Still yet another object of the present invention is to provide a new and improved wall mounting bracket, wherein the device may be readily fabricated from materials that permit relative economy and are commensurate with durability.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a front side perspective view of the present invention.

FIG. 2 shows a rear side perspective view of the present invention.

FIG. 3 shows a side perspective view of the present invention in use.

### DETAILED DESCRIPTION OF THE INVENTION

Reference is made herein to the attached drawings. Like reference numerals are used throughout the drawings to depict like or similar elements of the wall mounting bracket. For the purposes of presenting a brief and clear description of the present invention, the preferred embodiment will be discussed as used for removably mounting a variety of items to a wall surface. The figures are intended for representative purposes only and should not be considered to be limiting in any respect.

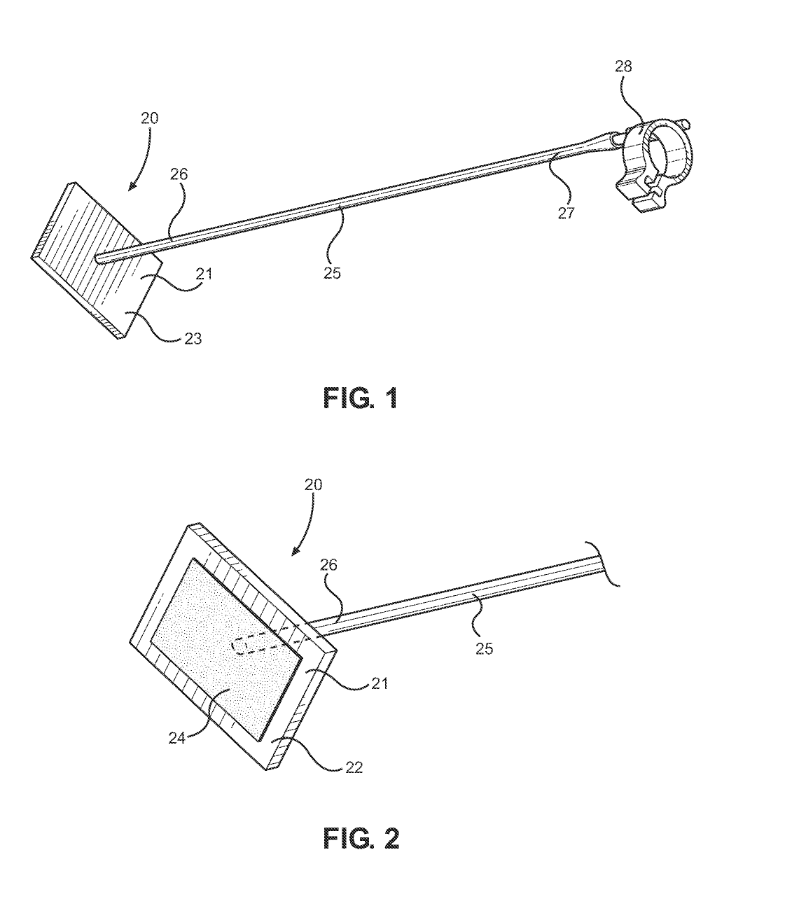

Referring now to FIGS. 1 and 2, there are shown a rear side perspective and a front side perspective of the mounting bracket 20. The mounting bracket 20 is configured to removably mount a variety of items to a wall surface or other similar support surface. These items include various household items, toys, figurines, action figures, and the like. The mounting bracket 20 is particularly advantageous as it allows for users to hang various tools for easy access or suspend favorite items to provide a customized decor.

The mounting bracket 20 includes a base portion 21 having an interior face 22 and an exterior face 23. Preferably, the base portion 21 is rectangular in shape, however, other shapes and sizes of the base portion 21 are alternatively used in other embodiments. These variations and sizes are deemed within the spirit and scope of the inventive embodiments described herein. The interior face 22 is configured to be placed flush against a wall surface via an adhesive 24. Preferably, the adhesive 24 is a strong epoxy glue, however, other suitable means of adhesive are also likewise contemplated. In some embodiments, the interior face 22 is removably secured to a wall surface via a fastener, such as a bolt, screw, or nail, among others.

The exterior face 23 of the base portion 21 includes an adjustable shaft 25 extending outwardly therefrom. Preferably, the adjustable shaft 25 is centrally located, however, it is readily envisioned that those of ordinary skill in the art will anticipate a variety of other preferable locations for the shaft to be disposed on the exterior face 23 that achieve the function, purpose and advantages described herein. These alterations, variations, and modifications are likewise contemplated. The adjustable shaft 25 includes a first end 26 and a second end 27, wherein the first end 26 is permanently affixed to the base portion 21. The second end 27 includes a fastener 28 configured to removably fasten an item thereon.

The adjustable shaft 25 is preferably composed of a flexible or bendable material, such as a metal wire, which is still rigid enough to maintain a bent configuration while supporting items thereon. In some embodiments, the adjustable shaft 25 is composed from a gooseneck that allows for adjustment. In this way, the user can manipulate and bend the adjustable shaft 25 in order to reposition an item supported thereon without having to detach the base portion 21 from the wall surface.

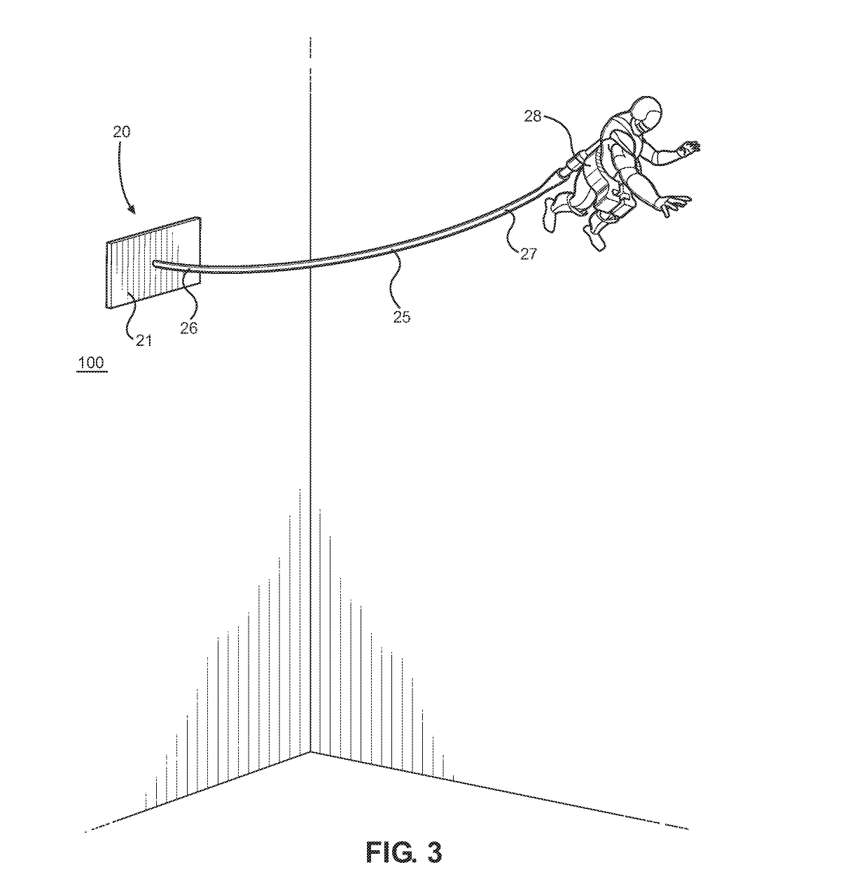

Referring now to FIG. 3, there is shown a side perspective of the mounting bracket 20 in use. The interior face of the base portion 21 is placed flush against the wall surface 100. The adjustable shaft 25 extends outwardly from the exterior face of the base portion 21. The adjustable shaft 25 is configured to be bent and manipulated to the user's desire in order to support an item thereon. Furthermore, the adjustable shaft 25 is also configured to maintain the bent shape manipulated by the user. The first end 26 is affixed to the exterior face of the base portion 21 and the second end 27 includes the fastener 28. The fastener 28 is configured to removably fasten to an item, such as the figurine illustrated, via clamping. Preferably, the fastener 28 is a C-shaped clamp, however, other suitable fasteners are alternatively used in other embodiments and therefore, likewise contemplated within this present disclosure.

In operation, a user can position a portion of the body of an action figure or figurine within the C-shaped clamp. The action figure fits frictionally within the clamp so that the action figure is partially encircled by the clamp. In some embodiments, the clamp is adjustable so that the tightness of the clamp on the action figure can be readily adjusted by the user.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A wall mounting bracket, comprising:
a base portion having an interior face and an exterior face; wherein said interior face is configured to be placed flush against a support surface and removably adhered thereto via an adhesive;
an adjustable shaft having a first end and a second end, wherein said first end is affixed to said exterior face of said base portion and said adjustable shaft extends outwardly therefrom, wherein said adjustable shaft is configured to be bent by a user and maintain a bent shape;
said second end includes a fastener thereon configured to removably clamp an item thereon.

2) The wall mounting bracket of claim 8 wherein said first end is centrally disposed on said exterior face of said base portion.

3) The wall mounting bracket of claim 8, wherein said fastener includes a C-shaped clamp.

4) The wall mounting bracket of claim 8, wherein said base portion is rectangular in shape.
